(19) United States
(12) Patent Application Publication
(10) Pub. No.: US 2013/0174442 A1
(43) Pub. Date: Jul. 11, 2013

(54) HEAT TREATMENT APPARATUS

(71) Applicants: Seonhyeok An, Yongin-si (KR); Kwanseop Song, Yongin-si (KR); Kyoungheon Heo, Yongin-si (KR); Jihyang Park, Yongin-si (KR)

(72) Inventors: Seonhyeok An, Yongin-si (KR); Kwanseop Song, Yongin-si (KR); Kyoungheon Heo, Yongin-si (KR); Jihyang Park, Yongin-si (KR)

(73) Assignee: Samsung SDI Co., Ltd., Yongin-si (KR)

(21) Appl. No.: 13/562,890

(22) Filed: Jul. 31, 2012

Related U.S. Application Data
(60) Provisional application No. 61/583,529, filed on Jan. 5, 2012.

(51) Int. Cl. F26B 3/04; F26B 25/06; F26B 13/04; F26B 19/00; F26B 21/06

(52) U.S. Cl. 34/549; 34/68; 34/565; 34/620

(57) ABSTRACT

An embodiment of the present invention provides a heat treatment apparatus, which can improve a thermal processing speed by increasing a transfer rate of heat energy applied to a heat treatment target using hot air and can reduce a temperature deviation in the heat treatment target. The heat treatment apparatus includes a hot air generator that generates hot air; a heat treatment furnace for performing a thermal process on a heat treatment target disposed therein using the hot air generated from the hot air generator; and a temperature radiator disposed in the heat treatment furnace to be spaced a predetermined distance apart from the heat treatment target, wherein the temperature radiator absorbs some of the hot air supplied from the hot air generator and supplies the same to the heat treatment target as radiant energy.

### CROSS-REFERENCE TO RELATED APPLICATIONS

This application claims the benefit of U.S. Provisional Application No. 61/583,529 filed Jan. 5, 2012 which is hereby incorporated by reference in its entirety.

### BACKGROUND

1. Field of the Invention

An embodiment of the present invention provides a heat treatment apparatus.

2. Background Art

Unlike primary batteries, which are not chargeable, secondary batteries are chargeable and dischargeable. Low-capacity batteries, which include a pack having one battery cell, are used for small portable electronic products, such as cellular phones, camcorders, and the like, and high-capacity batteries, which include a pack having multiple connected battery cells, are widely used as power supplies for hybrid vehicles, for example.

The secondary battery may be manufactured in various shapes, typically in a cylindrical shape or a prismatic shape. The secondary battery is manufactured by inserting an electrolyte and an electrode assembly formed by disposing a separator as an insulator between a positive electrode plate and a negative electrode plate in a case and installing a cap plate on the case. Positive and negative electrode terminals are connected to the electrode assembly and are exposed and protruded to the outside through the cap plate. The electrode assembly includes electrodes covered by a slurry.

A thermal process is generally performed on the slurry covered electrode by supplying a surface of the slurry with hot air as convection energy and also supplying a surface of the slurry with conduction energy using a contact-type heater, or supplying a surface of the slurry with heat as radiant energy using an infrared heater. In the thermal process, the heat energy is supplied to the heat treatment target by heating a heat source such as hot air, the contact-type heater or the infrared heater singly or in plurality. If a single heat source is used, compared to when a plurality of heat sources are used, the thermal processing speed of the heat treatment target is reduced and a temperature deviation on a surface of the heat treatment target may increase. Further, when the plurality of heat sources are used, it is necessary to supply each of the heat sources with power, increasing an amount of power used. Therefore, the electricity consumption may be increased, and if power supply is insufficient, power capacity should be increased.

### SUMMARY

According to an embodiment of the present invention, there is provided a heat treatment apparatus, which can improve a thermal processing speed by increasing a transfer rate of heat energy applied to a heat treatment target using hot air and can reduce a temperature deviation in the heat treatment target.

In order to accomplish these and other objects, an embodiment of the present invention provides a heat treatment apparatus including a hot air generator that generates hot air; a heat treatment furnace for performing a thermal process on a heat treatment target disposed therein using the hot air generated from the hot air generator; and a temperature radiator disposed in the heat treatment furnace to be spaced a predetermined distance apart from the heat treatment target, wherein the temperature radiator absorbs some of the hot air supplied from the hot air generator and supplies the same to the heat treatment target as radiant energy.

As described above, in the heat treatment apparatus according to an embodiment of the present invention, a heat treatment target is heat treated using convection energy of hot air and radiant energy, thereby improving a thermal processing speed by increasing a heat energy transfer rate to the heat treatment target and improving the reliability of thermal process by reducing a temperature deviation due to a difference in the absorbance of the heat treatment target.

In another aspect, the aforementioned needs are satisfied by a heat treatment apparatus of the present invention which, in this implementation comprises a furnace defining an interior space which is adapted to receive a heat treatment target. The apparatus in this implementation also includes a radiator positioned within the furnace at a first distance from the heat treatment target and a hot air supply system that provides hot air to the furnace. In this implementation the hot air supply system and the furnace are formed so that a portion of the hot air supplied to the furnace heats the radiator so that the radiator provides radiant heat to the heat treatment target and wherein the hot air supply system and furnace are formed so that a portion of the hot air supplied to the furnace provides convection heat to the heat treatment target.

### BRIEF DESCRIPTION OF THE DRAWINGS

FIG. 1 illustrates the principle of a heat treatment apparatus according to an embodiment of the present invention;

FIG. 2a illustrates a heat treatment apparatus according to an embodiment of the present invention;

FIG. 2b illustrates a heat treatment apparatus according to another embodiment of a hot air supply conduit shown in FIG. 2a;

FIG. 3a illustrates a heat treatment apparatus according to another embodiment of the present invention;

FIG. 3b illustrates a heat treatment apparatus according to another embodiment of a hot air supply conduit shown in FIG. 3a;

FIG. 4a illustrates a heat treatment apparatus for manufacturing an electrode plate of a secondary battery to which the heat treatment apparatus according to an embodiment of the present invention is applied; and

FIG. 4b illustrates a heat treatment apparatus for manufacturing an electrode plate of a secondary battery to which the heat treatment apparatus according to another embodiment of a hot air supply conduit shown in FIG. 4a.

### DETAILED DESCRIPTION

Hereinafter, examples of embodiments of the invention will be described in detail with reference to the accompanying drawings such that they can easily be made and used by those skilled in the art.

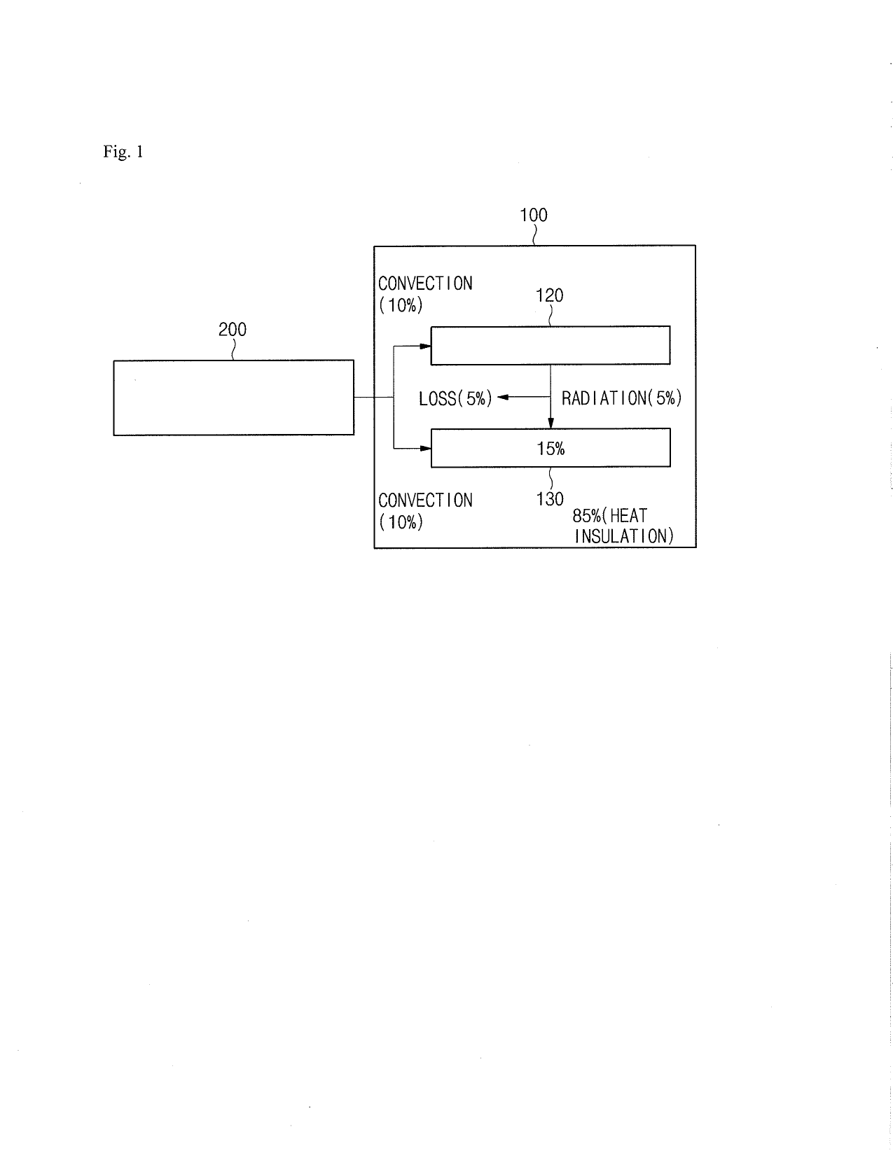

FIG. 1 illustrates the principle of a heat treatment apparatus according to an embodiment of the present invention.

Referring to FIG. 1, the heat treatment apparatus according to an embodiment of the present invention includes a heat treatment furnace 100 and a hot air supply unit 200.

The heat treatment furnace 100 includes a temperature radiator 120 and a heat treatment target 130 spaced a predetermined distance apart from each other.

The hot air supply unit 200 is connected to penetrate one side of the heat treatment furnace 100. The hot air supply unit 200 generates hot air to supply the same to the heat treatment furnace 100.

In the heat treatment furnace 100, the heat treatment target 130 is thermally processed by the hot air supplied from the hot air supply unit 200 and flowing in the temperature radiator 120, the heat treatment target 130 and between the temperature radiator 120 and the heat treatment target 130. That is to say, the hot air is supplied into the heat treatment furnace 100, some of the hot air is transferred to the heat treatment target 130 as convection energy, and the rest of the hot air is absorbed into the temperature radiator 120 and transferred to the heat treatment target 130 as radiant energy through the temperature radiator 120. For example, in the heat treatment furnace 100, 10% of convection energy and 5% of convection energy out of 100% hot air supplied from the hot air supply unit 200 and 5% of radiant energy supplied from the temperature radiator 120 may be transferred to the heat treatment target 130. Here, 85% based on 100% of the hot air supplied from the hot air supply unit 200 is used as insulation heat in the heat treatment furnace 100. However, the present invention does not limit levels of the convection energy and the radiant energy to those illustrated herein, but the levels of the convection energy and the radiant energy may vary according to materials and areas of the temperature radiator 120 and the heat treatment target 130.

When the hot air supplied to the heat treatment furnace 100 is transferred to the heat treatment target 130 as only the convection energy, there may be a region in which the convection energy is transferred well and a region in which the convection energy is not transferred well, which may lower a thermal processing speed of the heat treatment target 130. In order to avoid this, in this embodiment, the heat treatment target 130 and the temperature radiator 120 are both installed in the heat treatment furnace 100. This reduces the temperature deviation due to a difference between absorption levels of materials contained in the heat treatment target 130 while performing a rapid thermal process within a short time. This occurs as a result of transferring the convection energy of the hot air and the radiant energy of the temperature radiator 120 to the heat treatment target 130.

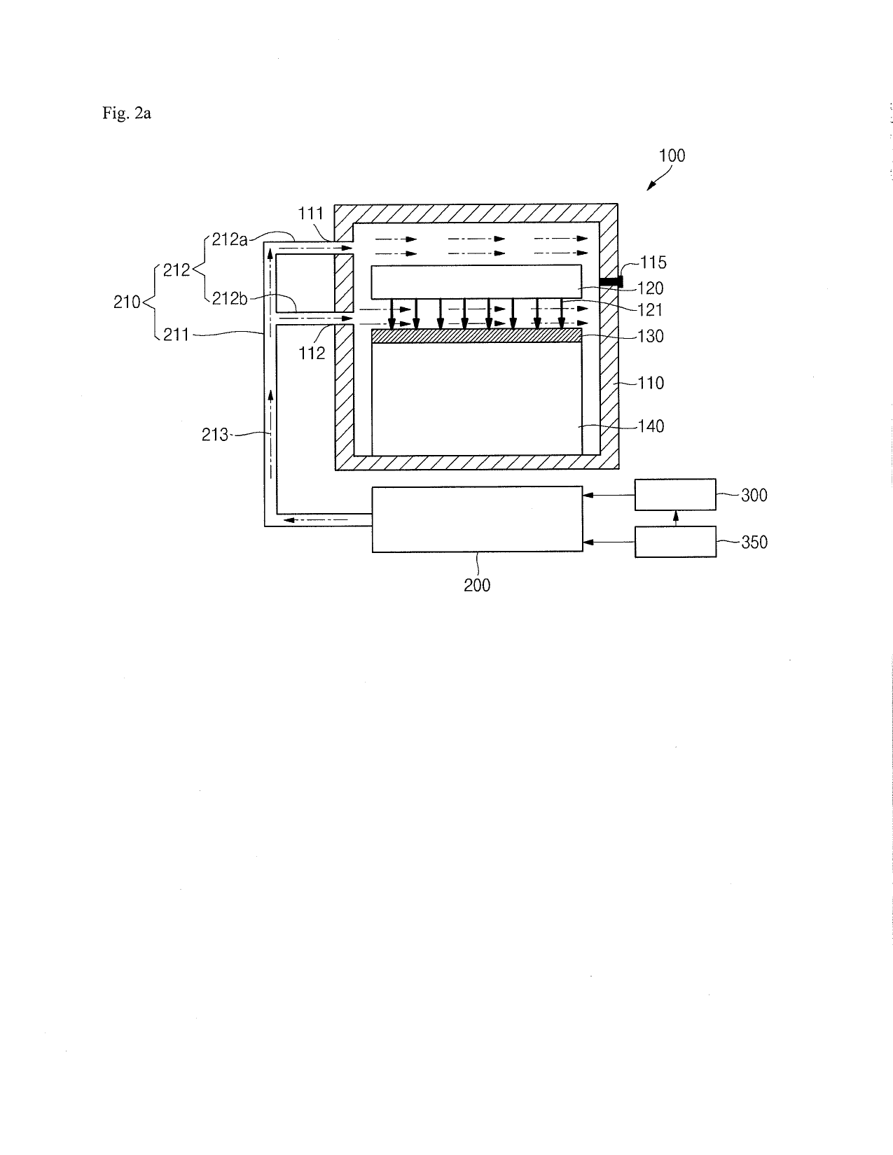

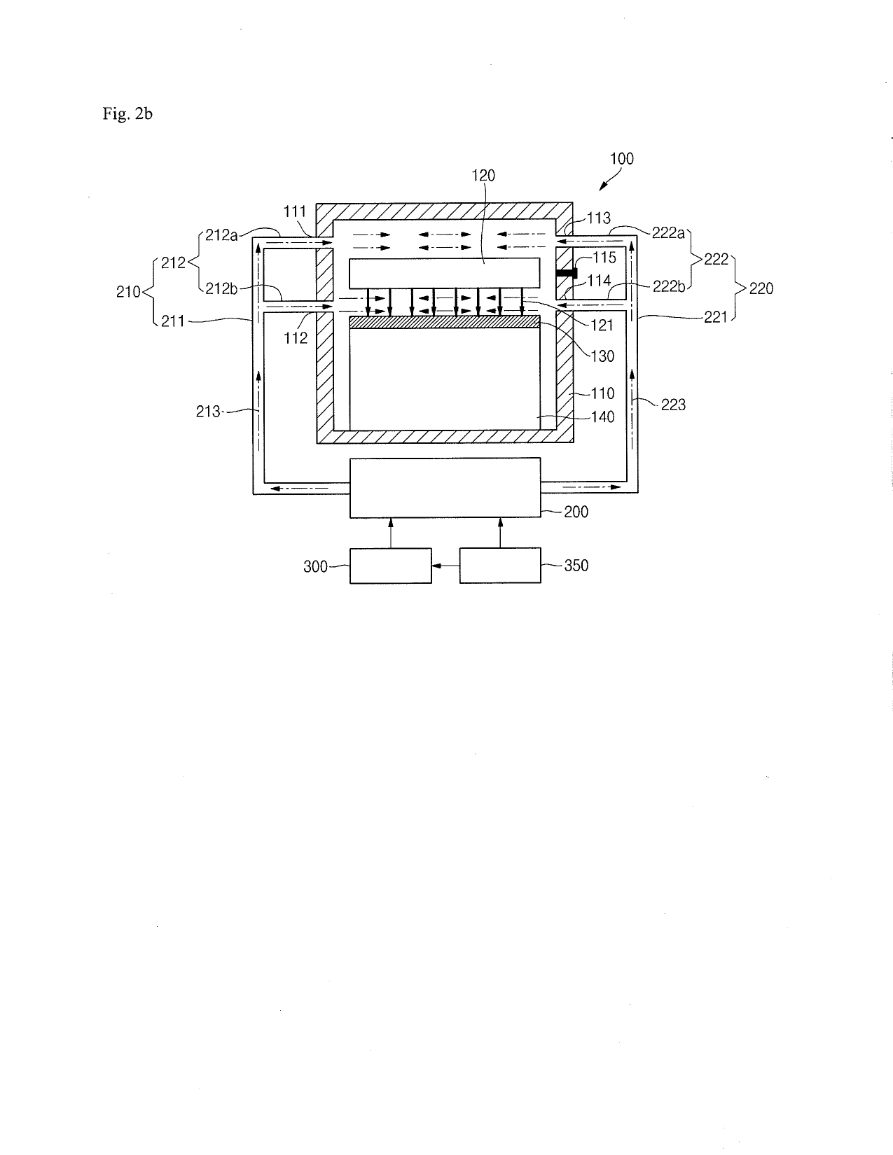

FIG. 2a illustrates a heat treatment apparatus according to an embodiment of the present invention, and FIG. 2b illustrates a heat treatment apparatus according to another embodiment of a hot air supply conduit shown in FIG. 2a.

Referring to FIGS. 2a and 2b, the heat treatment apparatus according to an embodiment of the present invention includes a heat treatment furnace 100, a hot air generator 200, a power supply unit 300 and a control unit 350.

The heat treatment furnace 100 performs a thermal process on the heat treatment target 130 disposed therein by applying hot air thereto. The heat treatment furnace 100 may be a furnace having a hollow space to allow the heat treatment target 130 to be disposed therein. The heat treatment target 130 is an object to be thermally processed. For example, the heat treatment target 130 may be a substrate having a layer formed thereon or an electrode plate having a slurry coated thereon. In addition, the heat treatment target 130 may be a material that efficiently absorbs the radiant energy supplied from the temperature radiator 120 having absorbed the hot air. In addition, a temperature sensor (not shown) that measure temperatures of the heat treatment target 130 may be installed within the heat treatment furnace 100. The temperature sensor may be a thermoelectric device, a pyrometer or a contact-type thermometer. However, the present invention does not limit the type of the temperature sensor to those listed herein.

The heat treatment furnace 100 performs a thermal process on the heat treatment target 130 disposed therein by applying hot air thereto. The heat treatment furnace 100 may be a furnace having a hollow space to allow the heat treatment target 130 to be disposed therein. The heat treatment target 130 is an object to be thermally processed. For example, the heat treatment target 130 may be a substrate having a layer formed thereon or an electrode plate having a slurry coated thereon. In addition, the heat treatment target 130 may be a material that efficiently absorbs the radiant energy supplied from the temperature radiator 120 having absorbed the hot air. In addition, a temperature sensor (not shown) that measure temperatures of the heat treatment target 130 may be installed within the heat treatment furnace 100. The temperature sensor may be a thermoelectric device, a pyrometer or a contact-type thermometer. However, the present invention does not limit the type of the temperature sensor to those listed herein.

The heat treatment furnace 100 includes throughholes 111 and 112, a temperature radiator 120 and a support unit 140.

The throughholes 111 and 112 are formed to penetrate a sidewall 110 of the heat treatment furnace 100 and are connected to a hot air supply conduit 210 for feeding hot air into the heat treatment furnace 100. The throughholes 111 and 112 may include a plurality of throughholes so as to correspond to the number of the hot air supply conduit 210. For example, the throughholes 111 and 112 are formed in the sidewall 110 of the heat treatment furnace 100 above and below with respect to the heat treatment target 130. Although not shown, the heat treatment furnace 100 has a discharge part formed on the sidewall 110 to discharge the hot air. In addition, referring to FIG. 2b, the throughholes 111, 112, 113 and 114 may be installed on both sidewalls with respect to a central portion of the heat treatment furnace 100 to be symmetrical to each other. Therefore, the amount and speed of the hot air supplied to the heat treatment furnace 100 are increased by installing the throughholes 111, 112, 113 and 114 at opposite sidewalls of the heat treatment furnace 100, thereby improving a thermal processing speed of the heat treatment target 130.

The temperature radiator 120 is disposed in the heat treatment furnace to be spaced a predetermined distance apart from the heat treatment target 130 and absorbs and radiates the hot air to be fed into the heat treatment furnace 100. The temperature radiator 120 may be positioned above the heat treatment target 130. The temperature radiator 120, which is positioned above the heat treatment target 120, may transfer radiant energy 121 directly to the heat treatment target 130. In addition, the temperature radiator 120 is spaced apart from the heat treatment target 130 to be parallel with a traveling direction of hot air 213.

The temperature radiator 120 is made of a metallic material. The metallic material may include aluminum, an aluminum alloy, copper, and so on. In addition, the temperature radiator 120 is formed by extruding, pressing or casting using the metallic material. In addition, in order to achieve high-efficiency infrared radiation, the temperature radiator 120 may be entirely coated with a highly conductive infrared radiation material (for example, a mixture of high-efficiency infrared radiation ceramic powder and a high-temperature binder). In addition, the temperature radiator 120 may be an infrared temperature radiator. Here, the infrared temperature radiator supplies radiation energy necessary to heat the heat treatment target 130 to a temperature for a desired process in a range of, for example, 600 to 1300° C.

The support unit 140 protruding from a bottom surface of the heat treatment furnace 100 supports the heat treatment target 130. The heat treatment target 130 is placed on a top surface of the support unit 140 and is thermally processed by the convection energy derived from the hot air 213 supplied to a top portion of heat treatment target 130 and the radiant energy 121 derived from the temperature radiator 120 positioned above the heat treatment target 130 to be spaced apart from the heat treatment target 130.

The hot air generator 200 is connected to the throughholes 111, 112, 113 and 114 of the heat treatment furnace 100 through the hot air supply conduits 210 and 220. The hot air generator 200 generates the hot air by installing a fin heater or an open radian heater and forcibly circulates the generated hot air through the hot air supply conduits 210 and 220. That is to say, the hot air generator 200 supplies the hot air into the heat treatment furnace 100 through the hot air supply conduits 210 and 220 and the throughholes 111, 112, 113 and 114. The hot air supply conduits 210 and 220 include linear pipes 211 and 221 and branch pipes 212 and 222. The linear pipes 211 and 221 are connected to the hot air generator 200, so that the hot air generated from the hot air generator 200 flows through the linear pipes 211 and 221. One ends of the branch pipes 212 and 222 are connected to the linear pipes 211 and 221, and the other ends opposite to the one ends thereof are connected to the throughholes 111, 112, 113 and 114 of the heat treatment furnace 100. In addition, the branch pipes 212 and 222 formed at opposite sides of the heat treatment furnace 100 are branched off into multiple pipes so as to be connected to the multiple throughholes 111, 112, 113 and 114, thereby allowing the hot air to flow therein. In addition, the linear pipes 211 and 221 and the branch pipes 212 and 222 may be installed at opposite sidewalls with respect to the central portion of the heat treatment furnace 100 so as to be symmetrical to each other. Therefore, the amount and speed of the hot air supplied to the heat treatment furnace 100 are increased by installing the branch pipes 211 and 221 and the branch pipes 212 and 222 at opposite sides of the heat treatment furnace 100, thereby improving a thermal processing speed of the heat treatment target 130. Here, the hot air preferably has a temperature in a range of 50 to 1000° C.

The power supply unit 300 is connected to the hot air generator 200 and supplies power to the hot air generator 200.

The control unit 350 is connected to the power supply unit 300 and the hot air generator 200 and controls operations of the power supply unit 300 and the hot air generator 200. In addition, the control unit 350 may control a temperature sensor to measure a temperature of the heat treatment target 130 in the heat treatment furnace 100 and to compare the measured temperature with a predefined temperature, thereby controlling the output of the hot air generator 200 or the power supply cycle of the power supply unit 300. Therefore, the control unit 350 may control the temperature of the heat treatment target 130 in the heat treatment furnace 100 to be maintained at the predefined temperature.

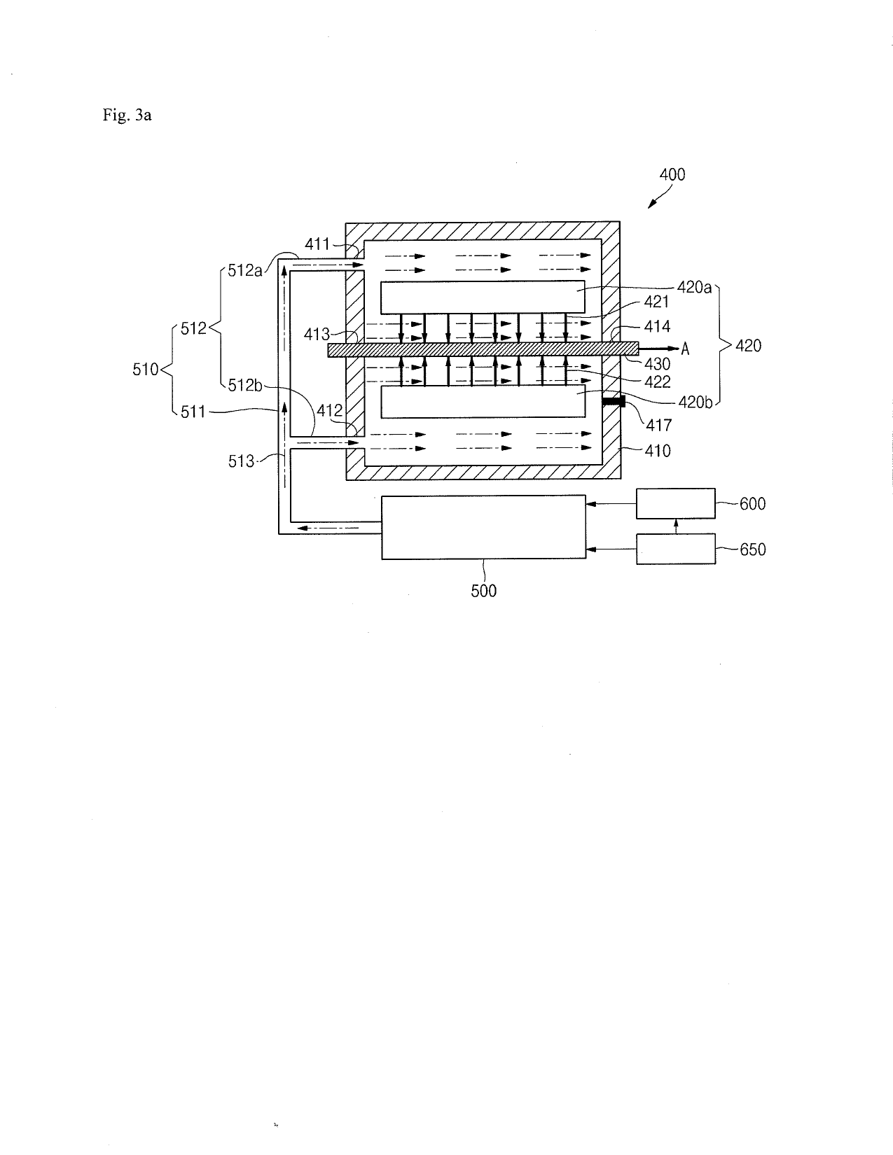

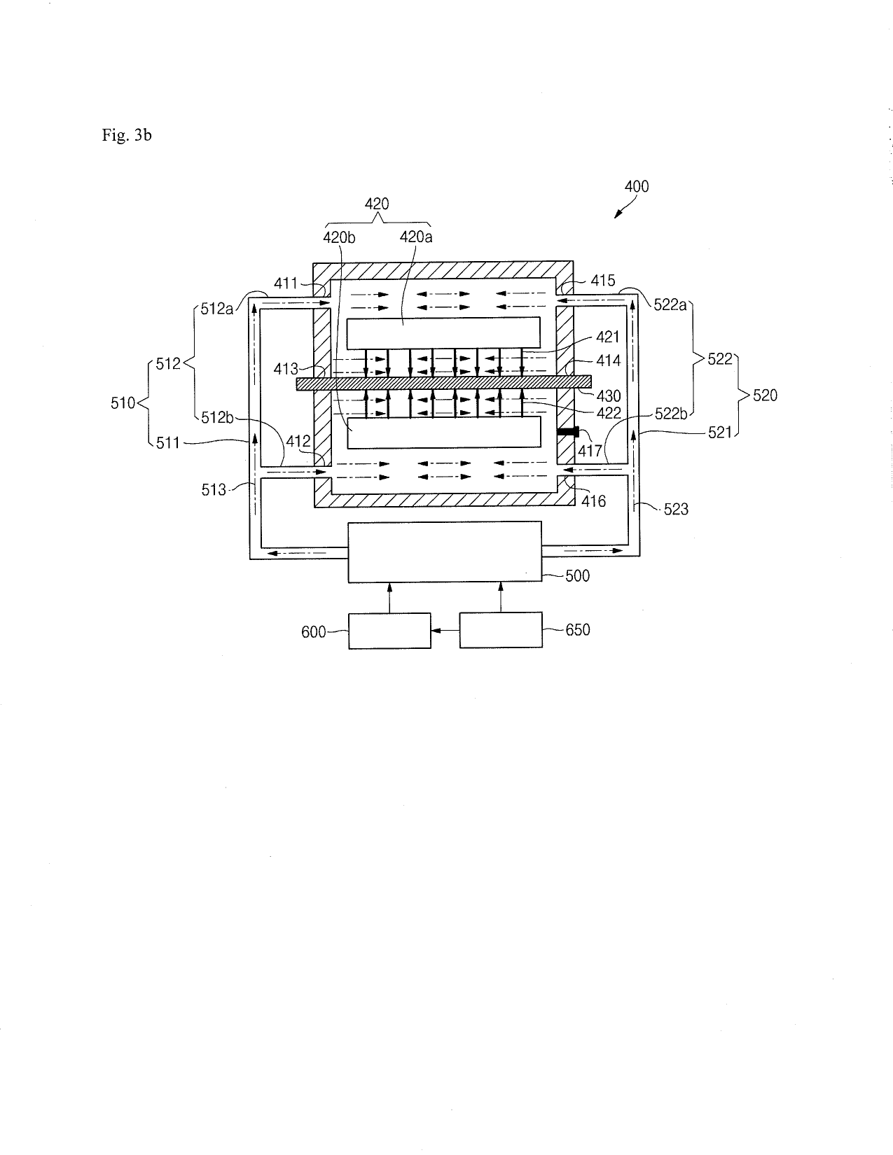

FIG. 3a illustrates a heat treatment apparatus according to another embodiment of the present invention and FIG. 3b illustrates a heat treatment apparatus according to another embodiment of a hot air supply conduit shown in FIG. 3a.

The heat treatment apparatus shown in FIGS. 3a and 3b is different from the heat treatment apparatus shown in FIGS. 2a and 2b in view of arrangement of a heat treatment target 430 and a temperature radiator 420. The following description will focus on configurations of the heat treatment target 430 and the temperature radiator 420, which are different from those shown in FIGS. 2a and 2b.

The heat treatment target 430 is disposed at a central portion within the heat treatment furnace 400 so as to penetrate the central region of the heat treatment furnace 400 and to move in a horizontal direction. The heat treatment target 430 is disposed to move in a vertical direction with respect to directions 421 and 422 in which radiant energy is supplied from the temperature radiator 420. Although not shown, the heat treatment target 430 is connected to a conveying means installed outside the heat treatment furnace 400. The conveying means moves the heat treatment target 430 by means of a control unit 650 in a direction (A) perpendicular to the directions 421 and 422 in which radiant energy is supplied from the temperature radiator 420, thereby allowing the heat treatment target 430 to be inserted into the heat treatment furnace 400 or to be discharged from the heat treatment furnace 400. In addition, the heat treatment furnace 400 has convey holes 413 and 414 formed at opposite sidewalls in the central portion of the heat treatment furnace 400 to move the heat treatment target 430.

The temperature radiator 420 includes an upper temperature radiator 420a and a lower temperature radiator 420b. The upper temperature radiator 420a is positioned above the heat treatment target 430. That is to say, the upper temperature radiator 420a is positioned above the heat treatment target 430 so as to be spaced apart from the heat treatment target 430. In addition, the lower temperature radiator 420b is positioned below the heat treatment target 430. That is to say, the lower temperature radiator 420b is positioned below the heat treatment target 430 so as to be spaced apart from the heat treatment target 430. The upper temperature radiator 420a and the lower temperature radiator 420b are disposed in a horizontal direction with respect to the directions in which the hot hair supplied from the hot air supply conduits 510 and 520 flows in the heat treatment furnace 400.

The heat treatment furnace 400 has throughholes 411 and 412 formed on a sidewall 410 above and below with respect to the convey holes 413 and 414 through which the heat treatment target 430 is conveyed. More specifically, the throughholes 411 and 412 are respectively formed at an upper side of a surface of the upper temperature radiator 420a, which is opposite to a surface facing the heat treatment target 430, and at a lower side of a surface of the lower temperature radiator 420b, which is opposite to the surface facing the heat treatment target 430. Referring to FIG. 3b, the throughholes 411, 412, 415 and 416 may be installed on both sidewalls with respect to a central portion of the heat treatment furnace 400 to be symmetrical to each other. Therefore, the amount and speed of the hot air supplied to the heat treatment furnace 400 are increased by installing the throughholes 411, 412, 415 and 416 at opposite sidewalls of the heat treatment furnace 400, thereby improving a thermal processing speed of the heat treatment target 430.

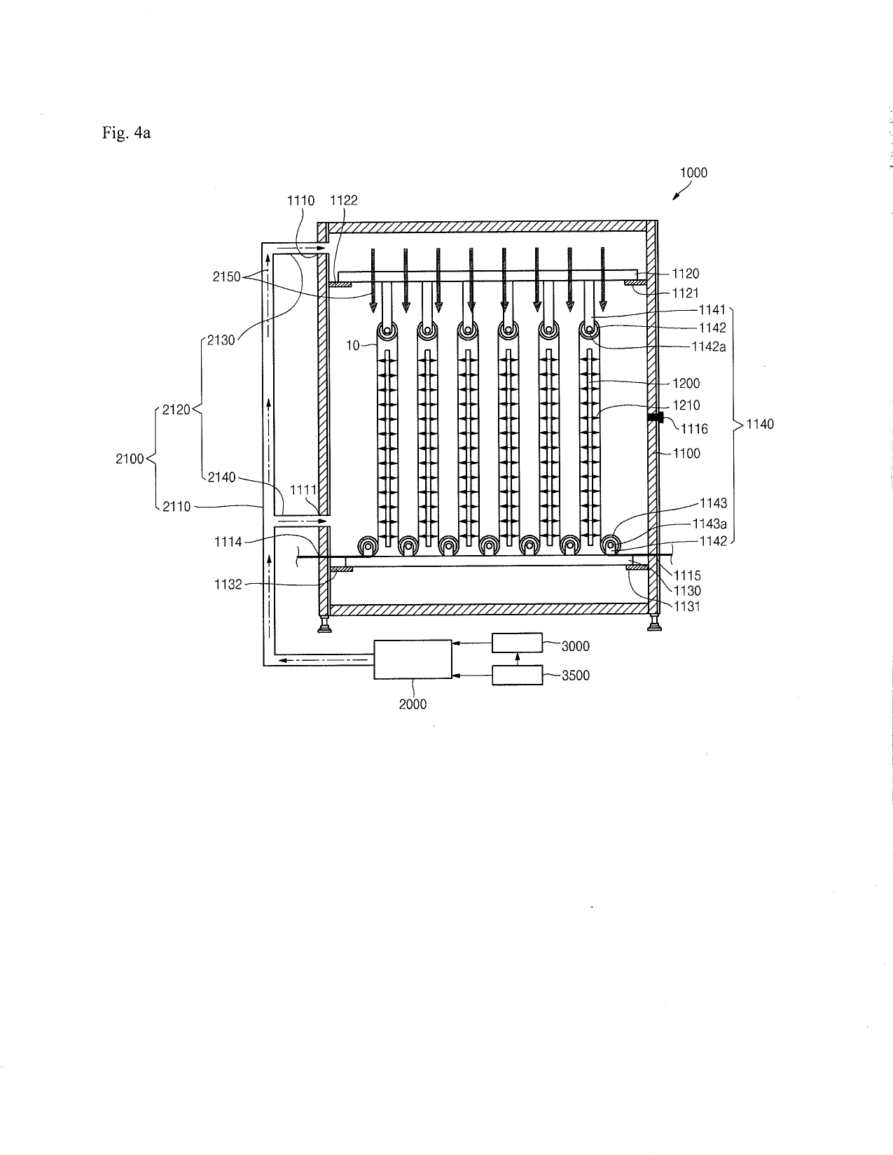

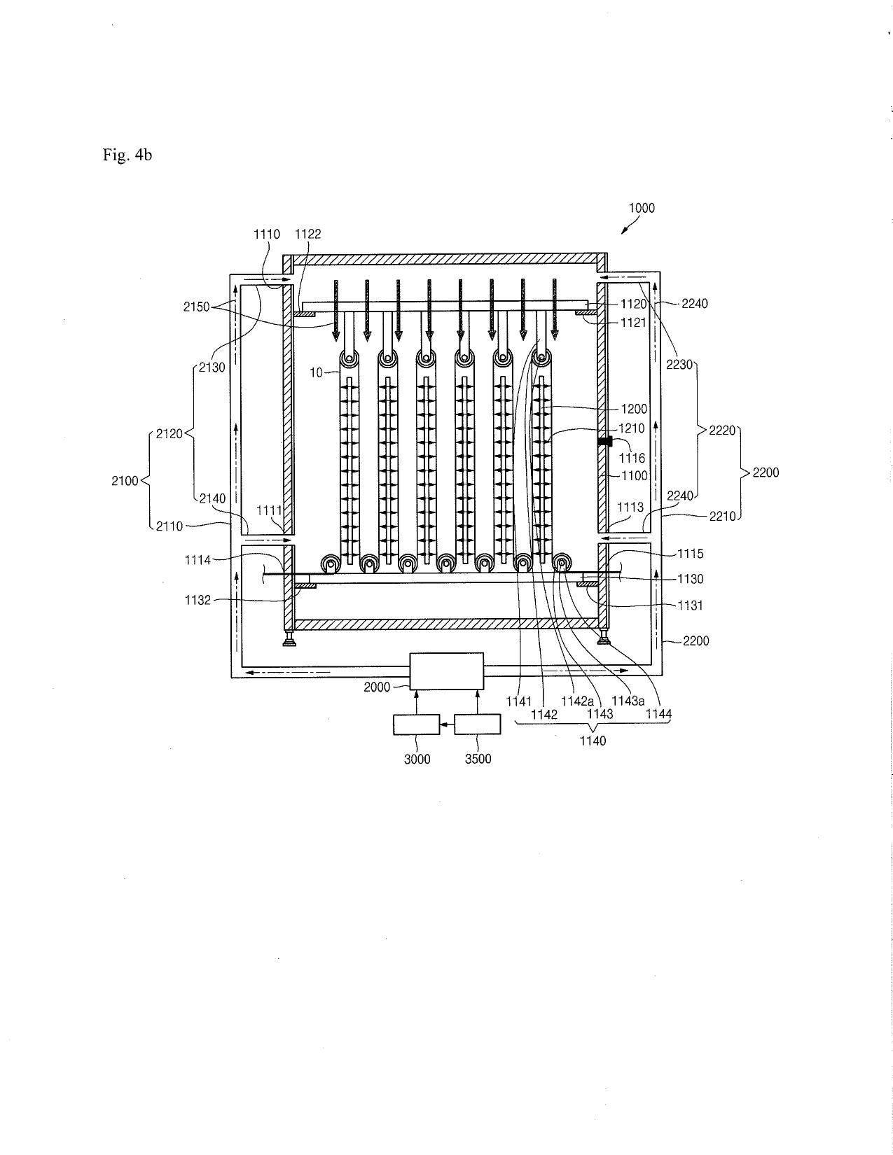

FIG. 4a illustrates a heat treatment apparatus for manufacturing an electrode plate of a secondary battery to which the heat treatment apparatus according to an embodiment of the present invention is applied, and FIG. 4b illustrates a heat treatment apparatus for manufacturing an electrode plate of a secondary battery to which the heat treatment apparatus according to another embodiment of a hot air supply conduit shown in FIG. 4a.

Referring to FIGS. 4a and 4b, the heat treatment apparatus for manufacturing an electrode plate of a secondary battery to which the heat treatment apparatus according to an embodiment of the present invention is applied, includes a heat treatment furnace 1000, a hot air generator 2000, a power supply unit 3000 and a control unit 3500.

The heat treatment furnace 1000 performs a thermal process by applying hot air to a slurry coated electrode plate (to be briefly referred to as an electrode plate) 10. The heat treatment furnace 1000 may be a furnace having a hollow space. In addition, a temperature sensor (not shown) that measures a temperature of the electrode plate 10 may be installed within the heat treatment furnace 1000. The temperature sensor may be a thermoelectric device, a pyrometer or a contact-type thermometer. However, the present invention does not limit the type of the temperature sensor to those listed herein. Meanwhile the heat treatment furnace 1000 may further include a separate conveying means to perform insertion of the electrode plate 10 into the heat treatment furnace 1000 or extraction of the electrode plate 10 from the heat treatment furnace 1000. In addition, the heat treatment furnace 1000 has an inlet hole 1114 for inserting the electrode plate 10 and a discharge hole 1115 for discharging the electrode plate 10.

The heat treatment furnace 1000 includes throughholes 1110 and 1111, support members 1120 and 1130, prop members 1121, 1122, 1131 and 1132, a roll-to-roll unit 1140 and a temperature radiator 1200.

The throughholes 1110 and 1111 are formed to penetrate a sidewall 1100 of the heat treatment furnace 1000 and are connected to hot air supply conduits 2100 and 2200 for feeding hot air into the heat treatment furnace 1000. The throughholes 1110 and 1120 may include a plurality of throughholes so as to correspond to the number of the hot air supply conduits 2100 and 2200. For example, the throughholes 1110 and 1120 are formed in the sidewall 1100 of the heat treatment furnace 1000 above and below with respect to the support members 1120 and 1130. Although not shown, the heat treatment furnace 1000 has a discharge part formed on the sidewall 110 to discharge the hot air. In addition, referring to FIG. 2b, the throughholes 1110, 1111, 1112 and 1113 may be installed on both sidewalls with respect to a central portion of the heat treatment furnace 1000 to be symmetrical to each other. Therefore, the amount and speed of the hot air supplied to the heat treatment furnace 1000 are increased by installing the throughholes 1110, 1111, 1112 and 1113 at opposite sidewalls of the heat treatment furnace 1000, thereby improving a thermal processing speed of the electrode plate 10. The support members 1120 and 1130 are shaped of plates and are disposed at upper and lower regions of the heat treatment furnace 1000. The support members 1120 and 1130 include an upper support member 1120 and a lower support member 1130. The upper support member 1120 is disposed at an upper portion of the heat treatment furnace 1000. In addition, the lower support member 1130 is disposed at a lower region of the heat treatment furnace 1000.

The prop members 1121, 1122, 1131 and 1132 are shaped of plates and are installed under the upper support member 1120 and the lower support member 1130. The prop members 1121, 1122, 1131 and 1132 include first prop members 1121 and 1122 and second prop members 1131 and 1132. One ends of the first prop members 1121 and 1122 come into contact with opposite bottom surface of the upper support member 1120, and the other ends opposite to the one ends of the first prop members 1121 and 1122 are coupled and fixed to opposite sidewalls of the heat treatment furnace 1000. The first prop members 1121 and 1122 fix the upper support member 1120 to the opposite sidewalls of the heat treatment furnace 1000. In addition, one ends of the second prop members 1131 and 1132 come into contact with opposite bottom surface of the lower support member 1130, and the other ends opposite to the one ends of the second prop members 1131 and 1132 are coupled and fixed to opposite sidewalls of the heat treatment furnace 1000. The second prop members 1131 and 1132 fix the lower support member 1130 to the opposite sidewalls of the heat treatment furnace 1000.

The roll-to-roll unit 1140 includes a first vertical part 1141, a first roll 1142, a second roll 1143 and a second vertical part 1144.

The first vertical part 1141 is shaped of a bar and protrudes in a vertically downward direction with respect to a lengthwise direction of the upper support member 1120. One end of the first vertical part 1141 is coupled to a bottom surface of the upper support member 1120, and the other end opposite to the one end of the first vertical part 1141 is coupled to the first roll 1142. The other end of the first vertical part 1141 is coupled to the center of the first roll 1142 through a rotation axis 1142a.

The first roll 1142 is coupled to the other end of the first vertical part 1141. The first roll 1142 is shaped of a cylindrical rotary roll that rotates, and includes a plurality of rolls. The first roll 1142 has an electrode plate 10 rolled around its surface to move the electrode plate 10 to the second roll 1143.

The second roll 1143 is coupled to a top surface of the lower support member 1130. The second roll 1143 is shaped of a cylindrical rotary roll that rotates, and includes a plurality of rolls. The second roll 1143 has the electrode plate 10 rolled around its surface to move the electrode plate 10 to the first roll 1142.

The second vertical part 1144 is shaped of a bar and protrudes in a vertically upward direction with respect to a lengthwise direction of the lower support member 1130. One end of the second vertical part 1144 is coupled to a top surface of the lower support member 1130, and the other end opposite to the one end of the second vertical part 1144 is coupled to the second roll 1143. The other end of the second vertical part 1144 is coupled to the center of the second roll 1143 through a rotation axis 1143a.

The first roll 1142 and the second roll 1143 may be formed of metallic rollers each having an appropriate diameter according the processing conditions. In addition, the first roll 1142 and the second roll 1143 may convey the electrode plate 10 rolled around each of outer circumferential surfaces thereof using separate driving means installed outside the first roll 1142 and the second roll 1143. In order to perform the operations, the first roll 1142 and the second roll 1143 are disposed to face the upper support member 1120 and the lower support member 1130 of the heat treatment furnace 1000 in a zigzag configuration, thereby allowing the electrode plate 10 rolled around each of outer circumferential surfaces thereof to be continuously conveyed.

The temperature radiator 1200 is shaped of a plate and is installed facing the lower support member 1130 from the first roll 1142 in the portion between adjacent second rolls 1143. That is to say, the temperature radiator 1200 is installed to be perpendicular to surfaces of the upper support member 1120 and the lower support member 1130 so as to be spaced apart from the electrode plate 10 rolled around the outer circumferential surfaces of the first roll 1142 and the second roll 1143. In addition, the temperature radiator 1200 absorbs and radiates hot air 2150 supplied into the heat treatment furnace 1000. That is to say, the temperature radiator 1200 absorbs the hot air supplied to the inside of the heat treatment furnace 1000 as convection energy and then radiates radiant energy 1210 to surfaces of the adjacent electrode plates 10. In addition, the temperature radiator 1200 is spaced apart from the electrode plate 10 and is disposed in parallel with a direction in which the hot air 2150 moves.

The temperature radiator 1200 is made of a metallic material. The metallic material may include aluminum, an aluminum alloy, copper, and so on. In addition, the temperature radiator 1200 is formed by extruding, pressing or casting using the metallic material. In addition, in order to achieve high-efficiency infrared radiation, the temperature radiator 1200 may be entirely coated with a highly conductive infrared radiation material (for example, a mixture of high-efficiency infrared radiation ceramic powder and a high-temperature binder). In addition, the temperature radiator 1200 may include a black bodycapable of transferring a high radiation energy.

The hot air generator 2000 is connected to the throughholes 1110, 1111, 1112 and 1113 of the heat treatment furnace 1000 through the hot air supply conduits 2100 and 2200. The hot air generator 2000 generates the hot air by installing a fin heater or an open radian heater and forcibly circulates the generated hot air through the hot air supply conduits 2100 and 2200. That is to say, the hot air generator 2000 supplies the hot air into the heat treatment furnace 1000 through the hot air supply conduits 2100 and 2200 and the throughholes 1110, 1111, 1112 and 1113. The hot air supply conduits 2100 and 2200 include linear pipes 2110 and 2210 and branch pipes 2120 and 2220. The linear pipes 2110 and 2210 are connected to the hot air generator 2000, so that the hot air 2150, 2250 generated from the hot air generator 2000 flows through the linear pipes 2110 and 2210. One ends of the branch pipes 2120 and 2220 are connected to the linear pipes 2110 and 2210, and the other ends opposite to the one ends thereof are connected to the throughholes 1110, 1111, 1112 and 1113 of the heat treatment furnace 1000. In addition, the branch pipes 2120 and 2220 formed at opposite sides of the heat treatment furnace 1000 are branched off into multiple pipes so as to be connected to the multiple throughholes 1110, 1111, 1112 and 1113, thereby allowing the hot air 2150, 2250 to flow therein. In addition, the linear pipes 2110 and 2210 and the branch pipes 2120 and 2220 may be installed at opposite sidewalls with respect to the central portion of the heat treatment furnace 1000 so as to be symmetrical to each other. Therefore, the amount and speed of the hot air supplied to the heat treatment furnace 1000 are increased by installing the branch pipes 2110 and 2210 and the branch pipes 2120 and 2220 at opposite sides of the heat treatment furnace 1000, thereby improving a thermal processing speed of the electrode plate 10. Here, the hot air 2150, 2250 preferably has a temperature in a range of 50 to 1000° C.

The power supply unit 3000 is connected to the hot air generator 2000 and supplies power to the hot air generator 2000.

The control unit 3500 is connected to the power supply unit 3000 and the hot air generator 2000 and controls operations of the power supply unit 3000 and the hot air generator 2000. In addition, the control unit 3500 may control a temperature sensor to measure a temperature of the electrode plate 10 in the heat treatment furnace 1000 and to compare the measured temperature with a predefined temperature, thereby controlling the output of the hot air generator 2000 or the power supply cycle of the power supply unit 3000. Therefore, the control unit 3500 may control the temperature of the electrode plate 10 in the heat treatment furnace 1000 to be maintained at the predefined temperature.

In the present invention, the temperature radiator 1200 is provided in the heat treatment furnace 1000 without using a contact-type heater using electricity or an infrared, thereby allowing the hot air supplied to the heat treatment furnace 1000 and not transferred to the electrode plate 10 to be absorbed by the temperature radiator 1200 to then be transferred to the electrode plate 10 as radiant energy. Accordingly, a thermal processing speed of the electrode plate 10 can be improved without using additional power while reducing a temperature deviation generated in the electrode plate 10.

While the present invention has been particularly shown and described with reference to exemplary embodiments of a heat treatment apparatus, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A heat treatment apparatus comprising:
a furnace defining an interior space which is adapted to receive a heat treatment target;
a radiator positioned within the furnace at a first distance from the heat treatment target;
a hot air supply system that provides hot air to the furnace, wherein the hot air supply system and the furnace are formed so that a portion of the hot air supplied to the furnace heats the radiator so that the radiator provides radiant heat to the heat treatment target and wherein the hot air supply system and furnace are formed so that a portion of the hot air supplied to the furnace provides convection heat to the heat treatment target.

2. The apparatus of claim 1, wherein the furnace further comprises a support and wherein the heat treatment target is positioned on the support.

3. The apparatus of claim 1, wherein the furnace has a first side and wherein the hot air supply system is coupled to the furnace via through holes in the first side.

4. The apparatus of claim 3, wherein the furnace has the first side and a second side and wherein the hot air supply system is coupled to the furnace via through holes in both the first and the second side so that hot air is supplied into the furnace from the first and second sides.

5. The apparatus of claim 4, wherein the through holes are symmetrically arranged on the first and second sides of the furnace with respect to a central portion of the furnace.

6. The apparatus of claim 1, wherein the radiator is formed of a metallic material.

7. The apparatus of claim 6, wherein the radiator is coated with a highly conductive infrared radiation material.

8. The apparatus of claim 1, further comprising a control system that controls the hot air supply system.

9. The apparatus of claim 8, further comprising a temperature sensor that provides signals indicative of the temperature to the control system that the control system uses to control the hot air supply system.

10. The apparatus of claim 1, wherein the radiator comprises a first and a second radiator member that are positioned about a central portion of the furnace and wherein the central portion of the furnace receives the heat treatment target therein so that the heat treatment target receives radiant heat from two first and second opposed directions.

11. The apparatus of claim 2, wherein the support is a movable support so that the heat treatment target is moved in a third direction that is perpendicular to the two first and second opposed directions as the heat treatment target is moved through the central portion of the furnace.

12. The apparatus of claim 11, wherein the furnace has a first and a second side and the movable support moves the heat treatment target from the first side to the second side through the central portion and wherein the hot air supply system provides hot air to both the first and the second sides.

13. The apparatus of claim 12, wherein the hot air is supplied to the first and second side of the furnace via through holes that are arranged so as to be symmetrical with respect to a central portion of the furnace.

14. The apparatus of claim 12, wherein the first side and the second side include convey holes through which the heat treatment target can be delivered to the movable support.

15. The apparatus of claim 1, further comprising a roll to roll support that defines a path through the furnace, and wherein the radiator is formed so as to extend along portions of the path.

16. The apparatus of claim 15, wherein the furnace includes a first, a second, a third and a fourth side wall and wherein first and second support members are suspended between a first and second side wall respectively and are spaced from the third and fourth side walls so as to define a space therebetween and wherein the path defined by the roll to roll support is formed in the space.

17. The apparatus of claim 16, further comprising prop members formed on the first and second side walls so that the first and second support members are positioned on prop members.

18. The apparatus of claim 16, wherein the roll to roll support comprises a plurality of roll assemblies mounted to the first and second support members so as to be aligned between roll assemblies mounted on the first support member to the second support member to define a path therebetween and wherein the radiator comprises a plurality of radiator members that extend in the space between first and second support members so as to extend along the length of the path between aligned roll assembles mounted on the first and second support members.

19. The apparatus of claim 16, wherein an inlet opening is formed in the first side wall and an outlet opening is formed in the second side wall that permits a continuous web of electrode plate to be provided to the furnace.

20. The apparatus of claim 16, wherein the hot air supply system provides hot air via both the first and second sides of the furnace.
